(19) United States
(12) Patent Application Publication
(10) Pub. No.: US 2016/0203523 A1
(43) Pub. Date: Jul. 14, 2016

(54) DOMAIN GENERIC LARGE SCALE TOPIC EXPERTISE AND INTEREST MINING ACROSS MULTIPLE ONLINE SOCIAL NETWORKS

(71) Applicant: Lithium Technologies, Inc., San Francisco, CA (US)

(72) Inventors: Nemanja Spasojevic, San Francisco, CA (US); Yize Li, San Francisco, CA (US); Adithya Shricharan Rao Srinivasa, San Francisco, CA (US); Ding Zhou, Milpitas, CA (US); Joseph Fernandez, San Francisco, CA (US); Prantik Bhattacharyya, San Francisco, CA (US)

(21) Appl. No.: 14/627,151

(22) Filed: Feb. 20, 2015

Related U.S. Application Data
(60) Provisional application No. 61/943,047, filed on Feb. 21, 2014.

(51) Int. Cl. G06Q 30/02; G06F 17/30

(52) U.S. Cl. CPC G06Q 30/0269; G06F 17/30539; G06F 17/30917; G06Q 50/01

(57) ABSTRACT

The system relates to a system and apparatus for a scalable engineering system deployed in production that mines topical interests from multiple social networks and assigns over tens of thousands of topics to hundreds of millions of users on a daily basis. The system extracts and analyzes features for topic inference that extend beyond authored text. The system uses a diverse set of features and cross network information can lead to a better understanding of a user's interests. This system focuses on assigning topics for a user that other users can socially recognize and acknowledge.

### BACKGROUND

Millions of people use social networks every day to communicate about a variety of subjects, publish opinions and share information. Understanding this data to infer user's topical interests is a challenging problem with applications in various data-powered products. The system disclosed herein mines topical interests from multiple social networks and assigns over tens of thousands of topics to hundreds of millions of users on a daily basis. The system continuously collects streams of user data and is reactive to fresh information, updating topics for users as interests shift. The system generates over 50 distinct features derived from signals such as user generated posts and profiles, user reactions such as comments and retweets, user attributions such as lists, tags and endorsements, as well as signals based on social graph connections. Using this diverse set of features leads to a better representation of a user's topical interests as compared to using only generated text or only graph based features. Using cross-network information for a user leads to a more complete and accurate understanding of the user's topics, as compared to using any single network.

### SUMMARY

The mining of topical interests for users from social media is an interesting and important problem to solve, because the insights gained can be applied to many applications such as recommendation and targeting systems. Such systems can deliver accurate results tailored to each individual user, only if the user's interests are well understood. The task of interest mining from social media has many challenges that mainly lie in the characteristics of the data, such as size, noise and sparsity. While the total volume of text generated on social media is huge, the size of each individual document tends to be very short. For example, posts on Twitter (tweets) are limited to 140 characters. Often the posts are also noisy due to abbreviations, grammatically inaccurate sentences, symbols such as emoticons and misspelled words. Finally, because many users on social media are inactive, sporadically active or only tend to be passive consumers of content, the textual content available for topical inference is sparse for such users.

The system disclosed herein is a scalable engineering system deployed in production that mines topical interests from multiple social networks and assigns over tens of thousands of topics to hundreds of millions of users on a daily basis. The system extracts and analyzes features for topic inference that extend beyond authored text. The system uses a diverse set of features and cross network information can lead to a better understanding of a user's interests. Unlike other systems that attempt to mine all topics for a user, this system focuses primarily on assigning topics for a user that other users can socially recognize and acknowledge. For example, Warren Buffett is recognized for topics like ‘Business’, ‘Finance’ and ‘Money’, while his personal interests may include ‘Cars’ and ‘Airplanes’. This approach helps in building applications that are meaningful in the context of the social identity of a user—in this example a business social identity and a personal-interest social identity.

The system is a social media platform that aggregates and analyzes data from social networks like Twitter, Facebook, LinkedIn, Google Plus and Instagram, and other sources like Bing Search Engine and Wikipedia. A user of the system can connect one or more of the above social profiles to form one unique profile. The system's topic system disclosed herein can take inputs from almost any social networking websites without limitation. In the examples herein, we explain the system focused on inputs from major social networking sites: Facebook (FB), Twitter (TW), GooglePlus (GP) and LinkedIn (LI).

To address the data challenges mentioned above, the system processes information shared by users to get more context around individual user documents. To address data noise problems, the system explodes text into n-grams and map against an internal dictionary of approximately 2 million phrases to generate bags-of-phrases. Search engines with language understanding may use simplified models of phrases, call bag models. Bag models ignore syntax and grammar and consider phrases just as sets of words without any relations.

The system addresses data sparsity problems by extracting signals from a user's reactions, such as comments or retweets on other user's posts. It also extract signals from posts in which a user is tagged or mentioned as well as from social graph connections, to increase data coverage for a given user.

The system combines the signals mentioned above to generate over 50 distinct features. The set of features are categorized as following: Generated, Reacted, Credited and Graph. Features derived from user authored posts and profile information are categorized as Generated. Reacted features come from user reactions such as comments and retweets. Credited features are built from signals such as lists, tags and endorsements, while Graph features are based on social graph connections. In experimentation, the system operated on an internal labeled corpus of over thirty-two thousand user-topic labels generated from real users.

There are a variety of topic detection systems that have been proposed, and topic inference is a well-studied area. However, the effectiveness of any given system is typically dependent on the specific domain or application under consideration. For example, modeling user interests is common practice for recommendation engines such as Amazon and Netflix, where the objective is to understand user interests in a particular domain such as products or movies. The user interests are often represented as latent vectors in recommender systems, and are derived from either explicit feedback, such as ratings, or implicit feedback such as clicks on products. Search engines also use topic inference to personalized results, where user interests are learnt from click-history and browsing behaviors from search logs. Similarly, clicks on ads are used to model user interests in the domain of online display advertising.

In many topic inference settings, the individual documents have clean data and rich context. This may include text from scientific publications, or text derived from a large corpus of natural language. In such scenarios, modeling user interests as unseen latent vectors, such as Latent Semantic Analysis (LSA) and Latent Dirichlet Allocation have been shown to provide good results.

Recent research has focused on topic modeling for users in social networks. User generated tags have been used to model user interests. Twitter, in particular, has been the focus of many studies that aim to characterize topical interests for users. Twitter has also been studied as a platform for conversation between users.

The system disclosed herein solves a problem that differs from the above work in at least three major aspects. First, in the context of short form social media messages, latent variable techniques such as LDA and LSA have a poorer performance as compared to using scientific publications or long-form text as the source. In some cases these techniques may identify topics for some users who have enough aggregated text, but they fail to do so for passive users who may not generate a lot of text themselves. Thus they cannot provide a scalable solution when identifying topics for millions of users. Second, while previous work has focused on single social networks for topic inference, as far as we are aware, this is the first attempt to incorporate multiple social profiles to form a single unique topic profile for a user. The context under which a single user creates or reacts to different messages in any given network is significantly different compared to the context in other networks. Third, the system solves the issue of identifying socially recognizable topics for a user, since this can have unique and interesting applications.

### BRIEF DESCRIPTION OF DRAWINGS

These and other features, aspects and advantages of the system will become better understood with regards to the following description, appended claims and accompanying drawings wherein:

FIGS. 1A and 1B depict a computer system and the network suitable for implementing the system for generating profit-optimal resource allocation solutions.

FIG. 2 is functional diagram illustrating the computer implemented system and the method for generating profit-optimal resource allocation solutions.

FIG. 3 is a hierarchical ontology overview diagram.

FIG. 4 is a table showing exemplary message sizes across various social media networks.

FIG. 5 is a table showing the percentage distribution of language across various social media networks.

FIG. 6 shows an exemplary registered user verbosity distribution.

FIG. 7 shows an exemplary phrase overlap across various social media networks.

FIG. 8 represents an overview of the system's data collection and data processing components.

FIG. 9 is an exemplary screenshot of the ground truth collection tool.

FIG. 10 is a table with an exemplary selected list of features and associated metrics.

FIG. 11 is a table with exemplary binary classification prediction for different feature sets typical of social networks.

FIG. 12 is a table showing exemplary statistics of a curated dataset.

FIG. 13 is a table showing an exemplary ranking performance comparison on user curated data.

FIG. 14 is a table showing exemplary topics assigned to some well-known personalities according to the present system.

FIG. 15 is a graph showing an exemplary distribution of registered users for a minimum number of topics assigned across different networks.

### DETAILED DESCRIPTION OF SYSTEM

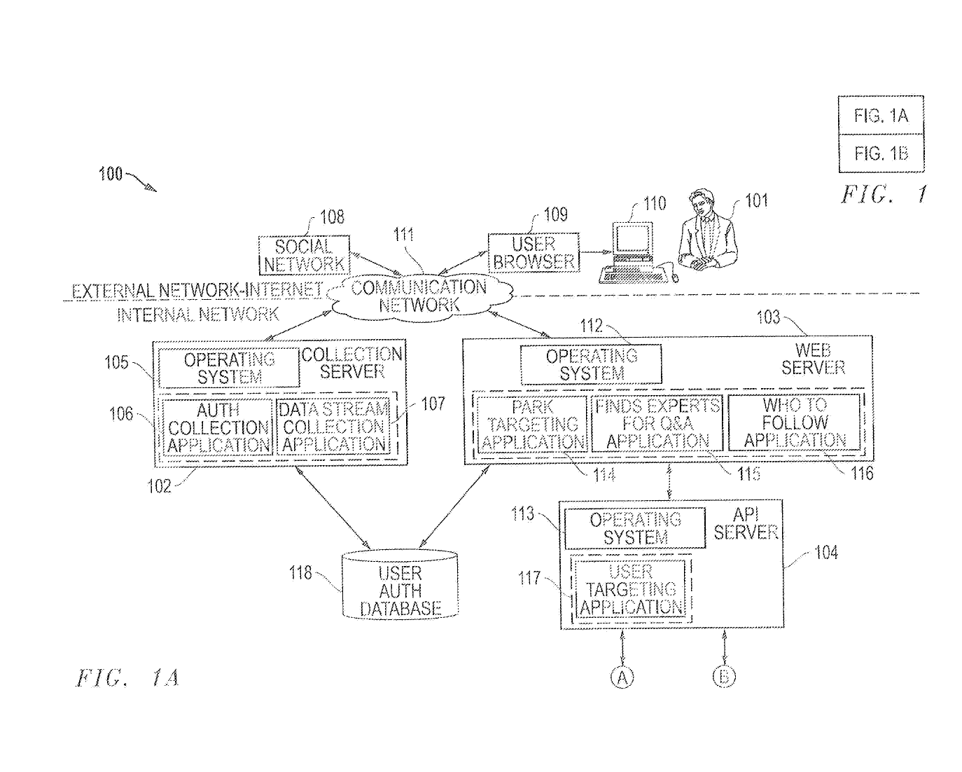

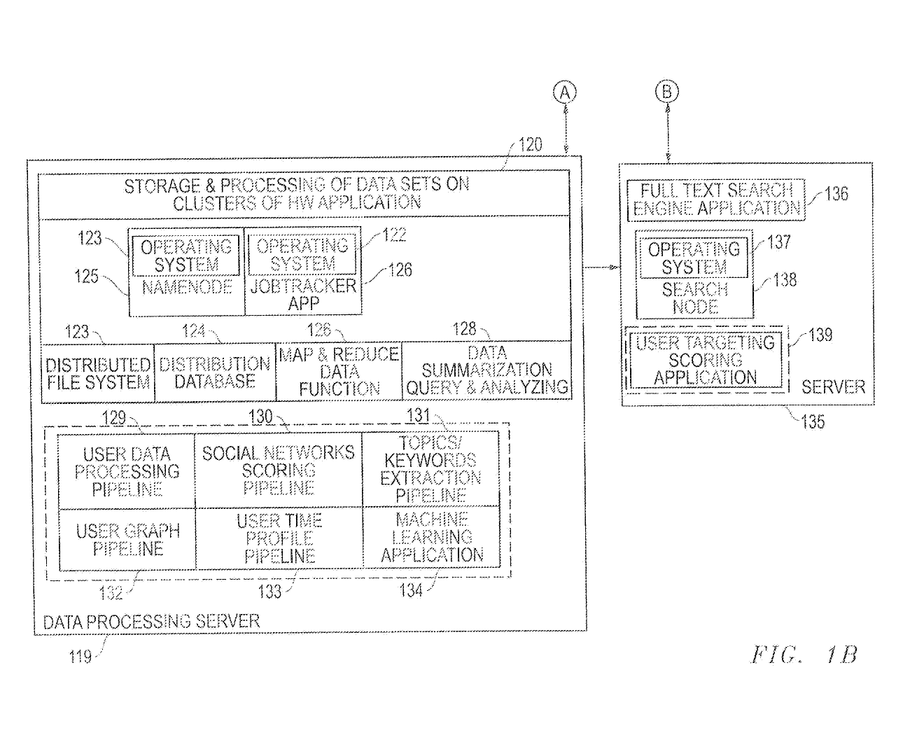

FIGS. 1A and 1B illustrate a computer system and network 100 suitable for implementing the system. It comprises a collection server 102, a web server 103, connected through a communication network 111 to a social network 108 and user through a user browser 109 and user interface 110. An API server 104 is connected to the web server 103. The collection server 102 hosts an operating system 105 contains an authentication collection application 106 and a data stream collection application 107 for collecting and processing data from social networks 108 and from users through a user browser 109 and user interface 110 connected to the system by a communication network 111. The web server 103 hosts an operating system 112 and a perk targeting application 114, a find experts question and answer application 115, and a who to follow application 116. The API server 104 hosts an operating system 113 and user targeting application 117. The collection server 102 and the web server 103 are connected to a user authentication database 118. The API sever 104 is connected to a data processing server 119 hosting storage and processing of data sets on clusters of hardware application 120. The data processing server 119 hosts multiple operations systems 121 through 122. The operating system run various application such as a file directory tree and tracking application 125 and job tracker applications 126.

The file directory tree and tracking application 125 keeps the directory tree of all files in the file system, and tracks where across the cluster the file data is kept. using a distributed file system that prides scalable data storage that spans large clusters of datasets. It can be an off-the-shelf file commercially available file system such as a Java-based files system such as Hadoop. Another operating system 122 on the data processing server 119 called the job tracker application 126 can run map and reduce tasks to access specific nodes in a cluster in the system that has data to determine the location of the data though the file system directly tree and tracking application 125. Although only two operating systems 121 and 122 are shown, there may be multiple operating systems and applications running in the data processing server 119.

The data processing server 119 also hosts a distributed file system storage application 123, distributed databased storage application 124, a map and reduce data application 127 and data summarization, query and analysis application 128.

The data processing server 119 also hosts a user data processing pipeline application 129, a social networks scoring pipeline application 130, a topics/keywords extraction pipeline application 131, a user graph pipeline application 132, a user time profile pipeline application 133 and a machine learning application 134.

The data processing server 119 and the API server 104 are connected to another server 135 that contains a full text search engine cluster search node application 136 running an operation system 137 with a full text search engine cluster search node 138 and a user targeting scoring application 139.

As used herein a server is a system (computer software and suitable computer hardware having a software operating system) that responds to requests across a computer network to provide, or help to provide, a network service. Servers can be run on a dedicated computer, which is also often referred to as “the server”, but many networked computers are capable of hosting servers. In many cases, a computer can provide several services and have several servers running. Servers are comprised of at least a computer processor and memory. Servers operate within client-server architecture; servers may be computer programs running to serve the requests of other programs, the clients. Thus, the server performs some task on behalf of clients. The clients typically connect to the server through the network but may run on the same computer. In the context of Internet Protocol (IP) networking, a server is a program that operates as a socket listener. Servers often provide essential services across a network, either to private users inside a large organization or to public users via the Internet. Typical computing servers are database server, file server, mail server, print server, web server, gaming server, application server, or some other kind of server. Numerous systems use this client and server networking model including Web sites and email services. An alternative model, peer-to-peer networking enables all computers to act as either a server or client as needed. The term server is used quite broadly in information technology. Despite the many server-branded products available (such as server versions of hardware, software or operating systems), in theory any computerized process that shares a resource to one or more client processes is a server. To illustrate this, take the common example of file sharing. While the existence of files on a machine does not classify it as a server, the mechanism which shares these files to clients by the operating system is the server. Similarly, consider a web server application (such as the multiplatform “Apache HTTP Server”). This web server software can be run on any capable computer. For example, while a laptop or personal computer is not typically known as a server, they can in these situations fulfill the role of one, and hence be labeled as one. It is, in this case, the machine's role that places it in the category of server. In the hardware sense, the word server typically designates computer models intended for hosting software applications under the heavy demand of a network environment. In this client-server configuration one or more machines, either a computer or a computer appliance, share information with each other with one acting as a host for the others. Operating systems may include but are not limited to MS Windows, Linux, Unix and the like.

The servers may be physical or virtual computer machines and may be co-located within the same physical server. The networked computers may be physical server computers or virtual machines. Virtual machines are software simulations of the hardware components of a physical machine (physical computer server). Although a physical machine host is required for implementation of one or more virtual machines, virtualization permits consolidation of computing resources otherwise distributed across multiple physical machines to fewer or even a single host physical machine. The servers may use software applications for allowing virtualization of servers, storage and networks, allowing multiple software applications to run in virtual machines on the same physical servers. Alternatively, the networked computers may be physical workstations such as personal computers, or a mixture of servers and workstations. The servers may be, for example, SQL servers, Web servers, Microsoft Exchange servers, Linux servers, Lotus Notes servers (or any other application server), file servers, print servers, or any type of server that requires recovery should a failure occur. Most preferably, each protected server computer runs a network operating system such as Windows or Linux or the like. The computer network connecting the servers and the user may be an Internet network or a local area network (LAN). The network may be implemented as an Ethernet, a token ring, other local area net protocol or any other network technology, such network technology being known to those skilled in the art. The network may be a simple topography, or a composite network including such bridges, routers and other network devices as may be required.

Some embodiments of the invention are implemented as a program product for use with a computer system such as, for example, the system 116 shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Thus, another embodiment of the invention provides a machine-accessible medium containing instructions effective, when executing in a data processing system, to cause the system to perform a series of operations for testing one or more programs upon the occurrence of an installation event. The series of operations generally include detecting an installation event comprising an upgrade of an application program, initiating a test sequence in response to detection of an installation event to test one or more applications, and detecting if an error occurs during execution of an initiated test sequence. The operations may further comprise maintaining a log file of error messages generated in response to detection of errors during execution of an initiated test sequence. The operations may further comprise initiating a test of an operating system in response to a detected change in the operating system.

Thus, in one embodiment, when an operating system is installed, test control software may cause a processor to execute a series of instructions to test each of a plurality of application programs, and may test the operating system itself. This establishes a baseline of performance against which to measure performance after an upgrade of an application program or the operating system. Embodiments therefore provide a ready tool for program developers to evaluate their programs

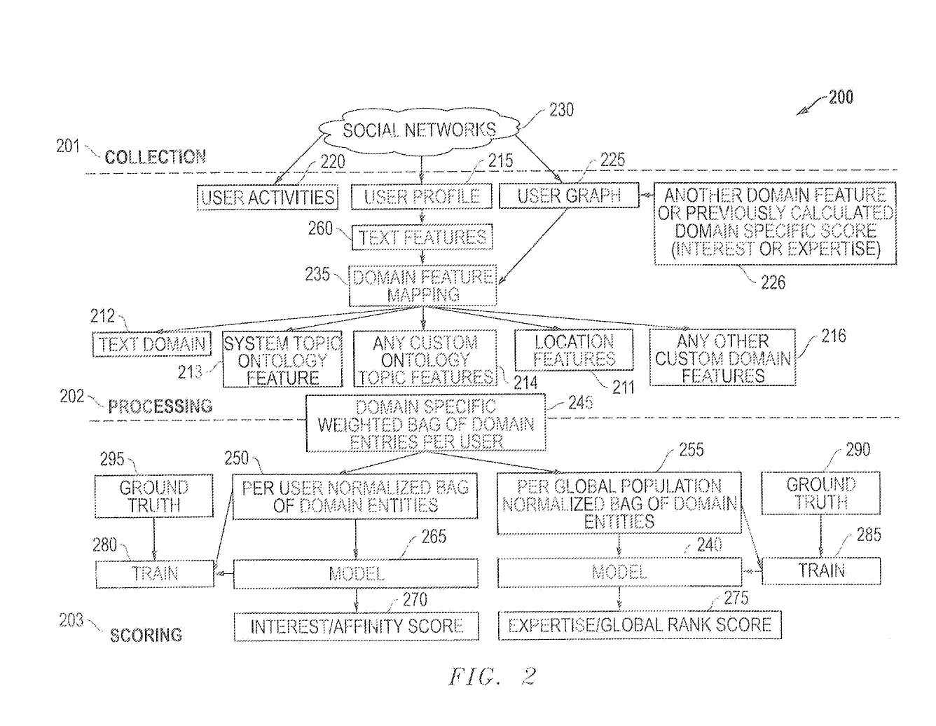

FIG. 2 represents a functional block diagram of the system 200. The system embodiment shown has with collection 201, processing 202 and scoring 203 components. When a user registers with the system, the user connects one or more social networks with the user's ‘token’, and grants permission to the system to collect and analyze the user's data through the network APIs. At the data collection stage, the system fetches the user's profile 215, activities 220 and the user's connection graphs 225 from various social networks 230. This data is parsed and stored in normalized form. The data processing pipeline expresses topical interests for each user as a ranked list of topics. The inferred topic list is used for multiple applications including generating a unified user profile, content recommendation, targeting and question answering.

For data collection 201, there are at least three data types: user profile 215, user activities 220 and user graph 225. Other features can be included such as domain features or previously calculated domain specific scores 226 such as interest 270 or expertise 275. For a user profile 215, a user may explicitly state some of his interests in his/her profile description on a social network. For example, the 160-character limited bio in a Twitter feed often contains information indicating the user's interests. On other social websites such as FB, users can edit their profiles to declare their interests in music, books, sports and other topics.

Various user activities 220 on social networks provide valuable signals for topic assignment and are collected as part of the data collection component. In general, the system collects authored status updates, shared URL pages, commented and liked posts, text and tags associated with videos and pictures, authored tweets, re-tweets and replies on other tweets, shared URL pages, subscribed, created and joined lists, comments on posts, skills stated by the user and endorsed by connections, authored messages, re-shares, comments, shared URL pages and plus-ones.

The system also collections the connection of user graph 225 within social networks. Such a connection graph has users as notes and directed edges between pairs of users. This includes follower and following edges on TW, which are unidirectional relationships, and friend edges on FB, which are bidirectional relationships. The social graph also contains a hidden interest graph. For instance, if a user follows “@NBA” then it is likely that the user is interested in basketball. The system leverages the user graph to discover the individual's interests.

For TW in particular, the system also collects the public data generated in the TW Mention Stream. This includes all tweets that include re-tweets, replies or a message that contains a “mention”, where a user is referenced with ‘@’ prefixed to his username. Finally, for well-known personalities, the system associates the current system profile with their Wikipedia page.

The system builds a comprehensive list of user interest topics at scale. The users under consideration include registered users who connect networks on the system, and unregistered users whose public data is available via social media networks such the TW stream. Overall the system assigns topics to hundreds of millions of unregistered users, and the number of registered users is in the order of millions.

The system may use a map and reduce infrastructure such as Hadoop to frequently bulk process the large amount of data collected a part of the domain feature mapping 235. Topic assignment is run daily as a bulk job, while machine learned models are built and improve, often in in an offline manner.

Text feature extraction application 260 is based on static content, or message/action based content. It takes as input object representing content and extracts the weighted bag of text features. Weights can be based only on number of repeats of extracted phrase within the text, or combination of# of repeats multiplied by external weight like number of likes on given message, or comments that were made on content from which text is extracted. Text to text features extraction 260 is based on dictionary of phrases of which to extract from text. The given text input is tokenized and creates all combinations of 1-n word grams and checks if given phrase candidates (and/or their normalized version) are within dictionary. If within dictionary we extract them and associate weight to them.

Generic object to text extraction is included in the text feature extraction application 260 and may be based on domain specific rules like: {message: ‘Swimming is making me swim.’, locationLatitude: 44.8040100, locationLongitude: 20.4651300} may translate to bag of text features looking like {‘swimming’: 1.0, ‘swim’: 1.0, ‘Location@Belgrade, Serbia’: 1.0}. Note that the custom extraction logic mapped location specific fields to the annotated text representing location and its standard human readable form. Example of user 2 different text features for a same user (user feature_name bag_of_phrases): sofronije TWITTER_MESSAGE 90 DAY {‘swimming’: 2.0, swim’: 1.0, ‘Location@Belgrade, Serbia’: 1.0} sofronije LINKEDIN_SKILLS {‘big data’: 2.0, ‘swimming’, ‘Location@San Francisco, USA’: 1.0}.

Domain feature mapping function 235 takes the given text features (bags of phrases) and maps the user to the domain feature mapping. Mapping can be strictly in 1:1 fashion or be implemented in a way where multiple text phrases map to same domain entity in which case weights of all text phrases mapping to same entity are aggregated and assigned to given entity. Since domain specific mapping happens later in pipeline step this system can support numerous entirety domains and be easily converted to support domain of interest. Example of user domain specific features for a same user (user feature_name bag_of phrases):

---Topics Domain---- sofronije TWITTER_MESSAGE 90 DAY {‘swimming’: 3.0}; sofronije LINKEDIN_SKILLS {‘big-data’: 2.0, ‘swimming’: 1.0}

---Location Domain---- sofronije TWITTER_MESSAGE 90 DAY {‘Belgrade, Serbia’: 1.0}; sofronije LINKEDIN_SKILLS {‘San Francisco, USA’: 1.0}.

Domain feature mapping can be generic and examples include:

```
    Topics (not limited to specific ontology, as domain feature
extraction is generic and modular)
    Text 212 (entities are phrases based on precalculated dictionary,
ex. freebase entities with their freebase machine ids)
    Locations 211 (City, State, Country, generic geo polygon)
    System stored ontology features 213
    Custom ontology topic features 214
    Other custom domain features 216
```

The above may include institutions (universities, corporations) and brands.

Normalization. For Interest (sometimes referred to assignment) each domain specific bag of features is scaled by maximum value within the bag. This can be expressed as b′[i]=f(b[i])|f(max_strength(b)) where f can be f(x)=x—regular normalization, or f(x)=log(x)—log-normalized. For Expertise for Oven user, feature name, and domain entity, is value(strength) is normalized by maximum value across population for a given feature_name, and given domain entity. Log normalization can be used, but regular normalization could be used too, depending if feature value distribution exhibits power distribution or not. Final product of normalization is (user, topic, feature vector) triplet, example below: sofronije ‘swimming’{TWITTER_MESSAGE_90 DAY: 1.0, LINKEDIN_SKILLS: 1.0}; sofronije ‘big-data’{LINKEDIN_SKILLS: 1.0}.

Model 240 creation and training. In the case of interest (also known as assignment), positive and negative results are gathered for user topic pairs. Given labels are associated to the feature vectors, and standard machine learning techniques are used to generate machine learned models and apply them. Per user normalized bag of domain entities 250 and per global population normalized bag of domain entities 255 are input to the models 240 and 265. Ground truth data 290 and 295 meaning collected online social network data that provides verified information about the user's interest in a user topic or other verified information about a domain is used to train 280 and 285 the models. For example, users may be listed as part of an online social network as student of the same school. Such an online community is known as a ground-truth community. In a ground truth community, members (which may be users, products or services) share a common functionality or purpose. The ground truth application is tested using evaluations based on known users, their graph first degree connections who are also know users or other social media users (such as TW users) whose data is available. In case of expertise for a given topic we gather rankings of evaluators friends within given topic. Ranked list is exploded in to user to user comparisons (u1, u2) where 1.0 label is assigned if u1 was ranked higher than u2, otherwise label is 0.0. Feature upon which we do training is represented as Fu1_vs_u2=Fu1−Fu2• To do machine learning one can do standard machine techniques, and finally score for each is calculated on expertise_score(u1)=M(Fu1_vs_u2}, where Fu2 is assumed to be zero vector for purpose of assigning score (M—represents score calculation function from the feature vector derived by machine learning model). Inputs to the models 240 and 265 include domain specific weighted bag of domain entitled per user 245 which can be further reduced to per user normalized bag of domain entities 250, per global population normalized bag of domain entities 255. Outputs of the models 240 and 265 include an interest affinity score which represents the relationship with other users. The more interconnected a user is with other users, the higher the affinity score 270. Outputs of the models 240 and 265 also may include an expertise/global rank score which represents a score that ranks the user's expertise on a given domain entity. The affinity score 270 and expertise/global rank score 275 can be applied in combination for a user engagement to ensure the user has an affinity towards certain domain affinity and user expertise to ensure the user is knowledgeable on a given domain entity. The outputs of the system can include user question to answerer targeting, that is using domain specific scores to detect top influencers and their answers to questions in which they are experts or may be interested in answering; perks targeting; rank listings; expert recommendations, recruiting, community detections and user content recommendations.

In the case of user-question to answerer targeting, the query the query is a question, and the asker of the question is the inquiring user. The retrieved users are the best candidates who are qualified to answer the question, and are likely experts in the domain. Here the question document is originally small, and is expanded by mapping it to related keywords and topics.

In the case of perks targeting, he query is a set of criteria which includes keywords, topics, and demographics, and the inquiring user is a given brand providing the perk. The retrieved user-list includes the best candidates qualified to receive the perk based on different success criteria. Such success criteria may be based on the user activity, such as users who would generate the maximum amount of social media content and activity related to the perk.

In the case of expert recommendations, the query is a set of criteria such as expertise in certain topics or keywords of interest to the inquiring user, and the result is a list of recommended experts for the user to connect with.

In the case of recruiting, the query is a list of skills and experience desired in a candidate, and the inquiring user is a company that is seeking candidates. The returned set of users are candidates who best match the skills specified and may have recently taken some actions indicating they are looking for a job.

In the case of user content recommendations, the query is a URL or article, and the inquirer is a user who wants to share the content among their audience. The retrieved users are members of the inquiring user's audience who would be the most interested in engaging with the content based on their topical interests.

FIG. 3 is a hierarchical ontology overview diagram. In the system, topics are represented as entries in an ontology tree, T. The ontology is manually curated and bootstrapped and may use a data structure called a graph (such as Freebase or Wikipedia Concepts. The ontology provides an explicit specification of topics and relationships among them and has a hierarchical tree structure as shown in FIG. 3 300. It has three levels: super 305, sub 310 and entity 315. The entity lowest level 315 contains specific entities, including people, things and places and are regularly updated. In one embodiment, included are close to 9,000 entities and includes proper nouns, popular terms in social media, and specific concepts 320. The sub level 310 contains sub-topics that are abstracted concepts and each corresponds to a cluster of entities. In the particular embodiment illustrated in FIG. 3, the sub-topics represent baking, beer and food 325. The super level 305 is the top level abstraction and contains super topics. In the embodiment shown here, the super topics are high level such as science and nature, food and drink, entertainment, education 330.

The system can support millions of registered users. After that, the user may connect with system using other social network profiles, e. g. LinkedIn, Google Plus, Instagram, Facebook or Twitter etc.

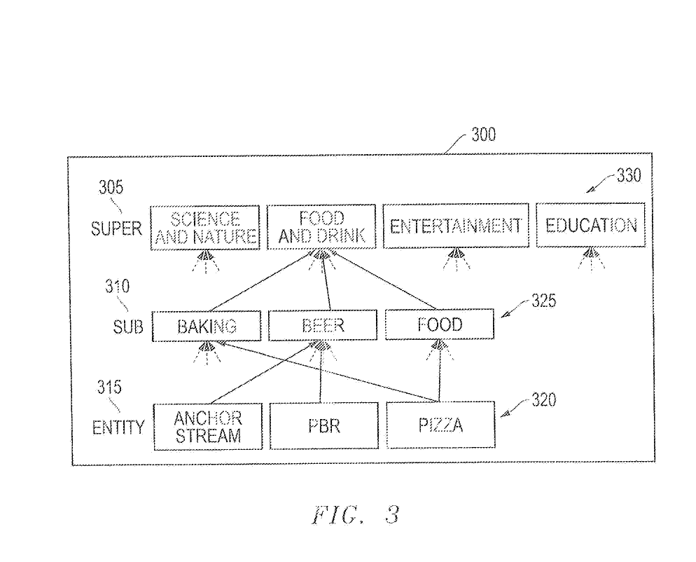

FIG. 4 is a table showing exemplary message sizes across various social media networks. One of the primary challenges faced by any system of this type is the size of text messages created by each user to infer correctly the topical interests. We present data in the table of FIG. 4 400 on message character count sizes on various social media networks to illustrate the challenge.

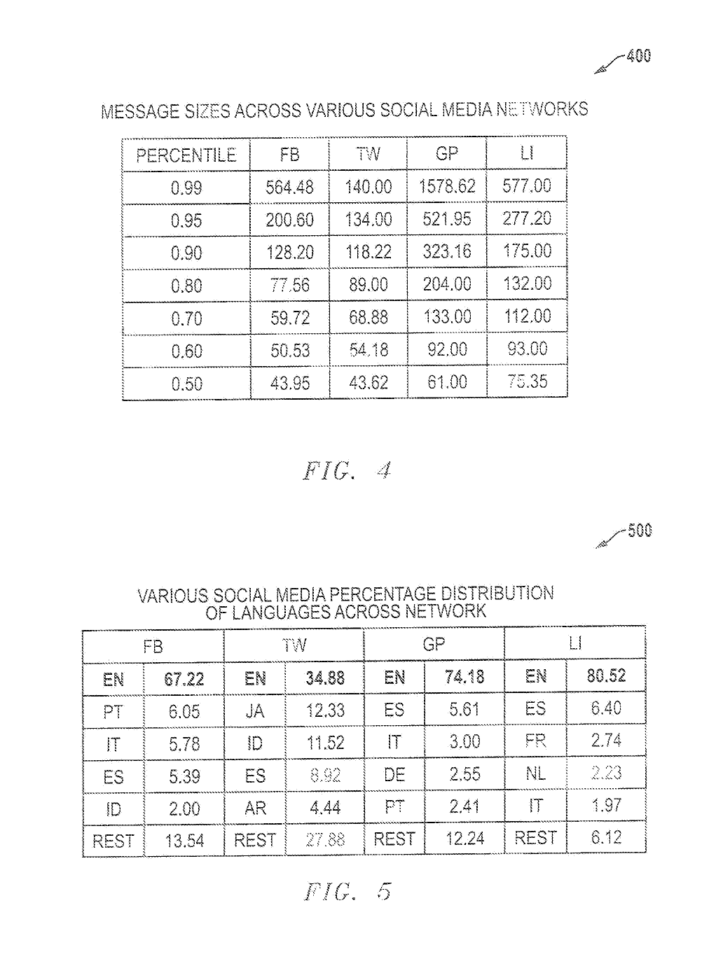

FIG. 5 is a table showing the percentage distribution of language across various social media networks 500. Topic detection is primarily in the English language but since English is used only by a limited number of user on each social network this crates another sparsity problem for non-English speaking users that is addressed by the system.

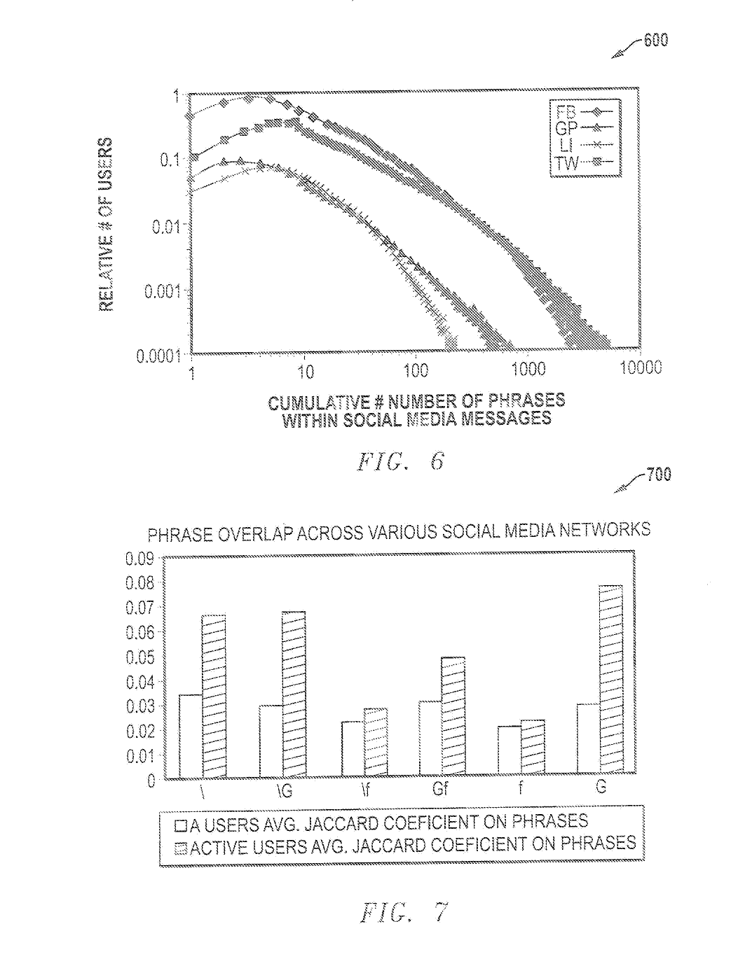

FIG. 6 shows the distribution of phrases used by users on each social network 600, on log-log scale with base 10. A phrase is defined as a communication from a user initiated on a social network. The x axis is the number of distinct phrases, which corresponds to the vocabulary size by users. The y axis shows the number of users as a function of their vocabulary size in past 90 days. The distribution approximately obeys the inverse power law, particularly on GooglePlus.

FIG. 7 shows the phrase overlap across various social media networks, 700. The system examines the different behaviors presented by users in different networks. In order to illustrate different user behavior and varied vocabulary choice across social networks, the system examines the phrase overlap in messages created by a user who has connected multiple social networks to their profile in the current system. We use jaccard coefficient to measure phrase overlap, P O(u, (Ni, Nj)) as follows:

P O(u,(N,N))=|{phrase in Ni}∩{phrase in Nj}|

|{phrase in N}∪{phrase in N}|

where Ni, Nj are i-th and j-th social network, respectively. The system then averages over all users for each pair of social networks. FIG. 7 shows the results. The phrase overlap value is very small on each pair; the highest overlap occurs be-tween postings across Facebook and Google Plus and is approximately 0.075. To gain deeper insights into the overlap, the system may focus on active users only. A user is considered as active in a pair of social networks if he has generated at least 100 distinct phrases in each network in last 90 days. The overlap extent increases; however it is still small and less than 0.1. The highest overlap occurs between postings across TW and FB and is approximately 0.035. The low phrase overlap for a single user helps the system aggregate topical interests from multiple social media and produce a more complete set of user interests.

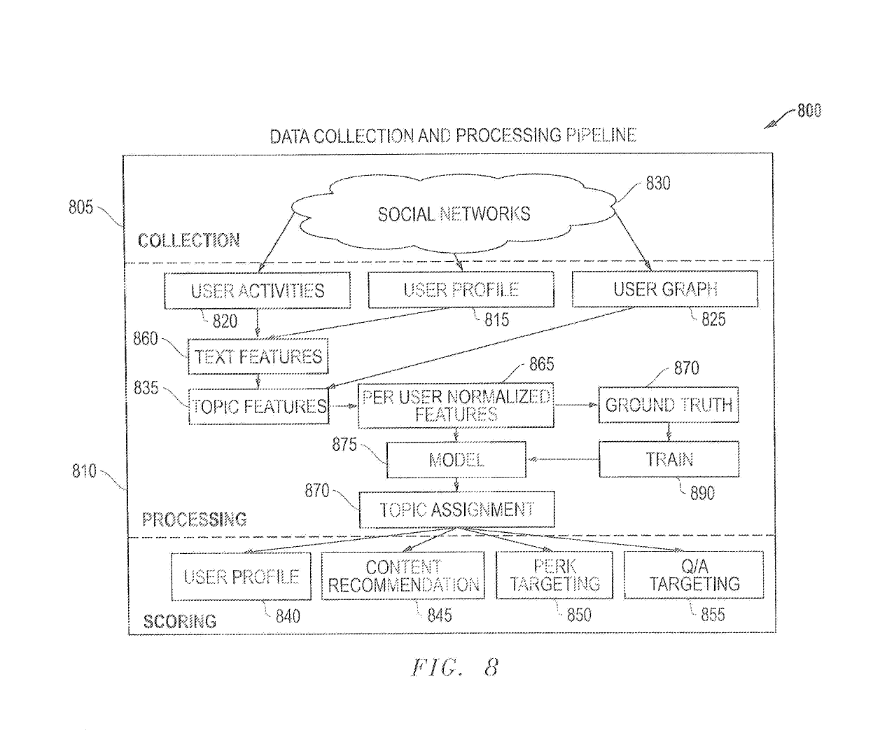

FIG. 8 represents an overview of the system's data collection and data processing components. The system has two main components: data collection 805, and data processing 810. When a user registers with the system, the user connects one or more social networks with the user's ‘token’, and grants permission to the system to collect and analyze the user's data through the network APIs. At the data collection stage, the system fetches the user's profile 815, activities 820 and the user's connection graphs 825 from various social networks 830. This data is parsed and stored in normalized form. The data processing pipeline expresses topical interests for each user as a ranked list of topics. The inferred topic list is used for multiple applications including generating a unified user profile, content recommendation, targeting and question answering.

For data collection 805, there are at least three data types: user profile 815, user activities 820 and user graph 825. For a user profile 815, a user may explicitly state some of his interests in his profile description on a social network. For example, the 160-character limited bio in a Twitter feed often contains information indicating the user's interests. On other social websites such as FB, users can edit their profiles to declare their interests in music, books, sports and other topics.

Various user activities 820 on social networks provide valuable signals for topic assignment and are collected as part of the data collection component. In general, the system collects authored status updates, shared URL pages, commented and liked posts, text and tags associated with videos and pictures, authored tweets, re-tweets and replies on other tweets, shared URL pages, subscribed, created and joined lists, comments on posts, skills stated by the user and endorsed by connections, authored messages, re-shares, comments, shared URL pages and plus-ones.

The system also collections the connection of user graph 825 within social networks. Such a connection graph has users as notes and directed edges between pairs of users. This includes follower and following edges on TW, which are unidirectional relationships, and friend edges on FB, which are bidirectional relationships. The social graph also contains a hidden interest graph. For instance, if a user follows “@NBA” then it is likely that the user is interested in basketball. The system leverages the user graph to discover the individual's interests.

For TW in particular, the system also collects the public data generated in the TW Mention Stream. This includes all tweets that include re-tweets, replies or a message that contains a “mention”, where a user is referenced with ‘@’ prefixed to his username. Finally, for well-known personalities, the system associates the current system profile with their Wikipedia page.

The system builds a comprehensive list of user interest topics at scale. The users under consideration include registered users who connect networks on the system, and unregistered users whose public data is available via social media networks such the TW stream. Overall the system assigns topics to hundreds of millions of unregistered users, and the number of registered users is in the order of millions.

The system may use the Hadoop MapReduce infrastructure to frequently bulk process the large amount of data collected. Topic assignment is run daily as a bulk job, while machine learned models are built and improve, often in in an offline manner.

The system has a warehousing solution for querying and managing large datasets resided in distributed storage. Features of the warehousing solution include a built-in data catalog and SQL-like syntax that is translated to a format for run-time. Having a data catalog to makes problems trackable as the number of distinct features types in the system grows. a Performing complicated data transformations with multiple joins and secondary sorts may be expressed as a single query. The system's data processing component has software program utilities for entity extraction, text to bag-of-topics mapping and language detection. It also allows for data aggregation, transformation and normalization 865. In the system's data processing pipeline, new features 860, 835 can be easily added and removed. Having this flexibility allows the system to support large number of features, some of which are network agnostic like those derived from message reactions or connection graphs, while others are more network specific like those derived from FB likes, TW lists, LI skills and so on. In one embodiment there are generate at least 50 distinct types of features 835.

In the data processing component 810, the model 875 includes the software code for generating bags of topics and topic assignments 880. Bags-of-phrases are first extracted from textual inputs, by matching against a dictionary of millions of phrases. Phrases are extracted as n-grams where n may vary from 1 to 10. The dictionary is updated daily using publically available information from websites, manual curation and top influential users' display names. As some of these sources change daily, the dictionary dynamically updates itself to include the latest phrases in social media. Bags-of-phrases are then mapped to the topic ontology and are transformed into bags-of-topics, effectively reducing the dimensionality of the text from 2 million phrases to around 10,000 topics. The system is agnostic to the ontology used, and any other ontology can also be applied in this framework. The system can use exact match and rule based synonym mapping approaches here, to avoid incorrect phrase-topic associations and to minimize false positives at this step. Alternate approaches include mapping cluster phrases to topics, or use latent variables to perform such mappings. The bags-of-topics thus generated have associated strengths for each topic in the bag. For most of the text based bags-of-topics we use the cumulative phrase frequency as the topic strength. For graph based bags-of-topics we use a slightly different approach, aggregating topic strengths from the user's first degree connections. Each bag-of-topics is associated with the corresponding user id, and is identified by a name representing the data from which the bag was derived. A feature vector is generated for each user-topic pair by exploding the bags-of-topics for a user, in order to formulate the problem as a binary classification problem for matching users to topics. We describe this procedure more formally in Section 4.1. The features are identified by the same name as the bag from which the topic under consideration originated. In the remainder of the paper, we will use feature names interchangeably to represent both the individual entry in a feature vector for a topic-user pair, as well as the corresponding bag-of-topics for a user.

Topic feature 835 generation using certain naming conventions such as <network>_<source>_<attribution>. Each feature Each feature is rep-resented as a combination of three characteristics that annotate—(a) the social network in which feature originated, (b) the source data type, and (c) the attribution relation of a given feature to the user. The network feature is the social network from which the data originated such as TW, FB, GP, LI, WIKI. The source feature captures the input data source, and optionally the derivation method when the same source may be interpreted in different ways. Text and social graph based sources are the two major inputs from which features are generated.

Text based sources originate from text associated with messages, posts, profiles, lists, videos, photos, or URLs shared. The system fetches shared URLs and extract text from the HTML, as well as the text from meta tags annotating the title, description and keywords of a URL. This enables the system to gain additional context about content with respect to a user. User graph derived features are calculated by aggregating topical interest of a user's first degree social graph. The first degree user graph topics are bootstrapped using some individual features which have high coverage and precision, for example TW Lists. Since topics are assigned daily, subsequent graph features are generated using topic assignments from the previous day. For the graph based bags-of-topics, we associate raw strengths as:

$$s ( {t}_{i} \vert u ) = {\sum }_{{BT}_{u}^{k} ∈ {BT}_{u}} {w}_{k} s ( {t}_{i} \vert {BT}_{u}^{k} )$$

where Gᵤ is the social graph of the user u, and v is a first-order neighbor of u. These strengths are also normalized using min-max normalization as described previously. Examples of such graph sources include FRIENDS on FB, and FOLLOWING and FOLLOWERS on TW.

The Source feature may optionally also include the time window considered for generating the feature. Since users' interests on social media may vary over time, some inputs may be indicators of topical interests only temporarily, while others such as country of birth, or professional interests, may indeed be long term indicators of topics associated with a user. We therefore consider inputs in a 90 day window to capture the temporal nature of changing topical interests, and an all-time window for the more permanent inputs.

Attribution: Attribution denotes the relation of the input source to the user. It may be one of the following:

1. Generated: Originally generated or authored content by the user, including posts, tweets, and profiles. This also includes comments which are attributed as generated, to the person who authored the comment.

2. Reacted: Content generated by another user (actor), but as a reaction to content originally authored by the user under consideration. This includes comments, re-tweets, and replies.

3. Credited: In this case the user has no direct association with the content from which the feature was derived. Examples include text that is associated with the user because he was mentioned with tags, or added to lists and groups by other users.

The most obvious attribution is Generated, which is based on text that the user has authored himself. Traditionally, this has been the primary input used to infer topics, but in the context of social media, this may often be insufficient or inaccurate. Users typically talk about a variety of subjects casually, such as “I had a late lunch today”, which does not necessarily indicate the user's interest in lunch or food. In addition, self-authored posts may cover only temporary or partial interests. For example, Bill Gates uses his Twitter account to primarily talk about topics like ‘Philanthropy’, ‘Books’, ‘Malaria’ and ‘HIV infection’. While his work as a philanthropist is captured by textual input from tweets, it's essential that the system also assigns topics like ‘Software industry’ and ‘Microsoft’. Thus generated inputs by users themselves may be inaccurate or insufficient to derive topical interests for users. To address these issues, we consider two other categories of text to derive topical signals.

The first is Reacted text, which considers messages included in comments or replies that were created by other

‘actors’, in reaction to an original message created by user. In this case we attribute the text of the comment or reply to the original message author and label it with the Reacted attribution. For some users the amount of text generated through reactions greatly exceeds the amount of original text, thus providing a lot more context and a much better signal for topic inference.

The second attribution that we consider is Credited. In this case the user is only indirectly involved with the signal under consideration, and neither generates, nor directly provokes the creation of the input with which he is associated. Instead, other users in the social network associate certain messages or content to the original user. Examples of such inputs are tweets in which a user is mentioned, or posts on FB where a user is tagged, or recommendations written by colleagues on LI, or a user being listed as a member of a TW list. These messages provide strong signals for topics associated with a user, because they indicate how other members of the social network perceive the user's topical interests. This attribution is important especially in the case of celebrities who may not be regular content creators themselves, but indirectly generate text via users who talk about and mention them.

The alert reader may have also noticed that the Generated, Reacted and Credited categories are analogous to the first person, second person and third person views used in language and grammar.

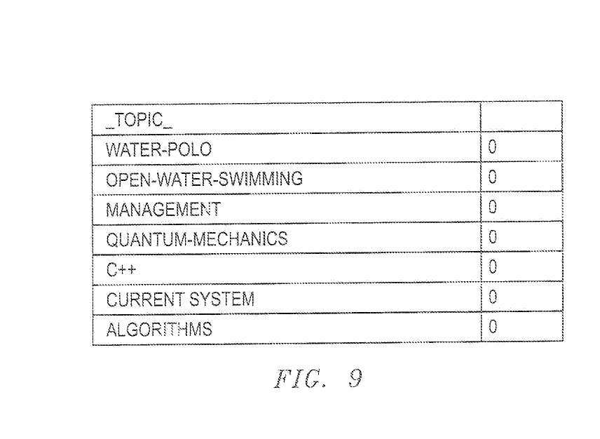

Models 875 are build based on the features described above. In one embodiment, a web application collects ground truth data with labels for user-topics 865. Ground truth data means collected online social network data that provides information about the user's interest in a user topic. For example, users may be listed as part of an online social network as student of the same school. Such an online community is known as a ground-truth community. In a ground truth community, members (which may be users, products or services) share a common functionality or purpose. The ground truth application is tested using evaluations based on known users, their graph first degree connections who are also know users or other social media users (such as TW users) whose data is available. The system randomly assigns topics to the users' first degree connections. The evaluator then gives positive or negative feedback, depending if the topic is good or bad match for his connection. If participants are uncertain about the relevance of the topic-user pair, they skip the evaluation for that pair. The screenshot of the ground truth collection tool is shown in FIG. 9.

The ground truth data generates labels for socially recognizable user topics. A participant does not evaluate himself to ensure that personal biases are separated from the feedback. In an embodiment of a dataset, analysis showed that out of all pairs of user-topic pairs that received more than one vote, only 27% have conflicting feedback. The conflicting votes contribute to only 2.2% of all the votes that were collected, suggesting that in most cases the association is clear.

The system solves the problem of predicting topics for a user using supervised learning. The data collected and ground truth data is used for training and evaluation.

As explained previously, multiple bags-of-topics are derived from different sources for each user. We explode these bags-of-topics, and for each topic-user pair (ti, u), we build a feature vector xi,u. The value of each feature in the vector

is the topic strength of ti given the bag-of-topics, BT k

xik=s(ti|BT k),

where BT k is the kth bag-of-topics for the user. We name the kth feature with the same name as the bag BT k. One of the primary contributions of this study is to analyze which features are indicative of a user's topical interests on social networks.

We find that textual input authored by users themselves accounts for at least one topic for only 58% of users on the labeled set. The remaining users either do not create enough text, or generate text that is not necessarily indicative of their topical interests. For such users we include reacted and credited signals in order to predict their topics, as described in the previous section.

We evaluate the performance of the topic prediction through traditional IR metrics:

Precision(P)=I{relevant topics}∩{retrieved topics}/|{retrieved topics}|

Recall(R) measures the fraction of relevant topics that are retrieved.

R=|{relevant topics}∩{retrieved topics}/{relevant topics}|

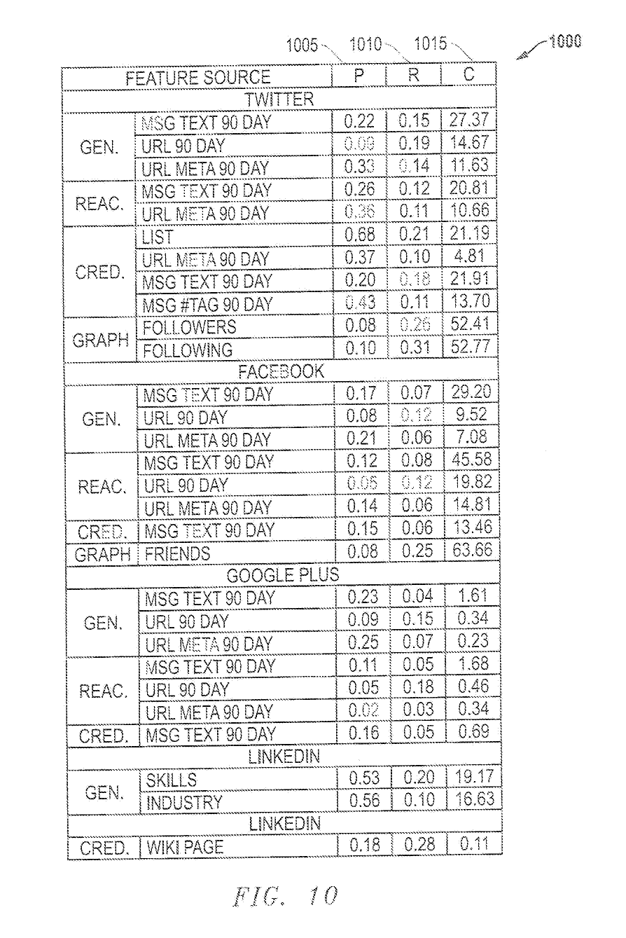

FIG. 10 shows a table 1000 with a selected list of features along with their Precision (P) 1005 and Recall (R) 1010 values as evaluated on the labeled set. In this case, the predicted topics for a user are the bag-of-topics associated with the feature. We also present the coverage (C) 1015 in terms of percentage of registered users who have the feature.

The credited list based features on Twitter and generated LinkedIn features have the highest individual predictive quality in terms of precision. Generated URL features typically have higher recall than other features, suggesting that shared URLs are a strong signal of a user's topical interests. We also find that the graph based features have the highest coverage and recall values, which highlights why these features can predict topics for users who are not very active themselves.

Given the bags-of-topics generated for users, the system accurately predicts the topic preference for each user. Feature vectors are generated from exploded bags-of-topics for user-topic pairs as described above. When a certain topic occurs in multiple bags for a user, then the feature vector for that pair will include all these values xj, and 0.0 values for features where it does not occur.

The problem can be classified as a binary classification problem, in which the system must learn automatically to separate topics of interest from those that are not relevant to the user. Several classification algorithms may be used, including those reported to achieve good performance with text classification tasks, such as support vector machines, logistic classifiers, and stochastic gradient boosted trees. In one embodiment, a stable performance was obtained with the logistic classifier. We predict the label by ŷ=P(y\tᵢ,u)=σ(x_{i,u}θ), where

$$σ ( a ) = \frac{1}{1 + {e}^{- α}}$$

is the sigmoid function. The label yε{0, 1} assigns 1 if the topic tᵢ is of interest to the user u, 0 otherwise

Models are trained using the feature vectors generated for the pairs against the labels from the labeled data. The final model applies weights Wₖ to get the final bag-of-topics, Tᵤ. The topic strength for a specific topic tᵢεTᵤ is:

$$s ( {t}_{i} \vert u ) = {\sum }_{{BT}_{u}^{k} ∈ {BT}_{u}} {w}_{k} s ( {t}_{i} \vert {BT}_{u}^{k} )$$

FIG. 11 is a table with exemplary binary classification prediction results for different feature sets typical of social networks. In addition to precision and recall, the F1 Score,

$$F 1 = \frac{2 PR}{P + R}$$

to measure performance as a tradeoff between precision and recall.

The table in FIG. 11 presents the performance of topic prediction using k-fold cross validation on the labeled set, where k=10 and the held out set is 20% of the data. Class 1 represents positive instances where the topic was correctly predicted, and class 0 represents negative ones, where the topic was correctly discarded. We consider the predictive power of different feature sets, and how they compare to the case when the full feature set is used. The “Feature Set” column indicates the feature subset used for the prediction. Insights gained by comparing the performance of using all features versus using only subsets of features:

Single Network Comparison: The precision when all features are used is higher than when we use only features from a single network like Twitter. This shows that increasing the information available for a user by using the user's presence on other networks improves the correctness of the predicted topics in both cases. While using features from only Facebook may yield a higher precision, the recall in this case is very low, and we are able to predict fewer topics for each user. These observations together imply that because of the nature of any given social network, a user may not reveal all his interests on any single network alone, making it necessary to use features from multiple networks.

Attribution Comparison: The performance when we use only features derived from user generated input, which includes text as well as shared URLs (GEN.) can be compared to using only features from the user's reacted and credited inputs (REAC.+CRED.). The generated set of features yield a high precision, but a low recall value. The reacted and credited features give a slightly lower precision, but slightly higher recall compared to the generated input. But using all inputs together yields a much higher recall value than using them separately. This shows that using only user generated text can predict much fewer topics for the user, as compared to using the generated, reacted and credited inputs together.

Graph Comparison: Graph based features (GRAPH) may play a role in topic prediction. Excluding graph based features gives a higher precision but a low recall value, and using only graph features provides a much higher recall value, with a slightly lower precision. This highlights the value of using graph features, because by the nature of the social networks, it is possible to predict topics for a user by considering the topics of the other users that he is connected to. But relying solely on graph based features gives some incorrect predictions, because of the possible noise introduced.

Using the complete set of features maintains a relatively high precision, while greatly improving recall. The results show that including multiple networks, generated text input, reacted and credited signals, and graph based features together gives the best performance overall, as indicated by the F1-score in FIG. 11. The system also achieves a 92% precision k, where k=10, on the full training set.

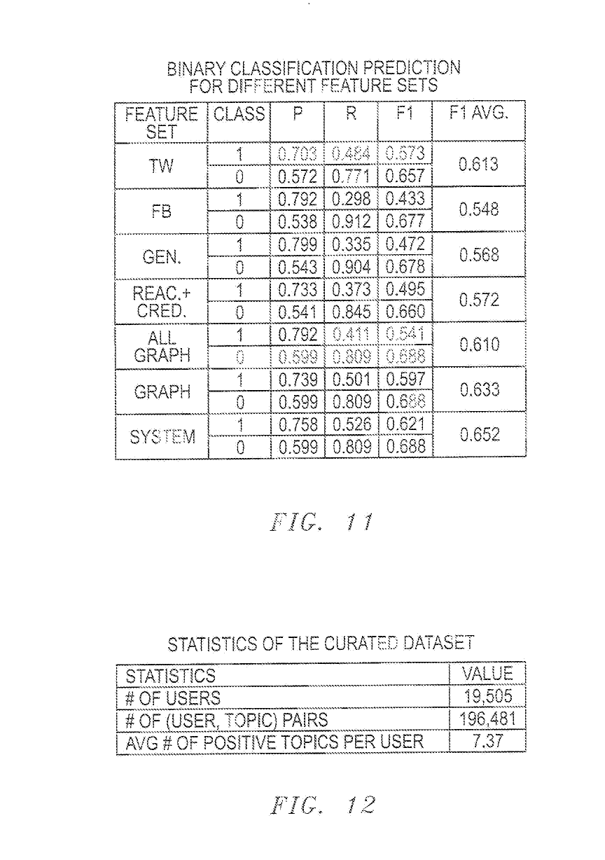

FIG. 12 is a table showing exemplary statistics of a curated dataset. The system displayed top 10 predicted topics in ranked order on each user's profile. Users could then add, delete, or reorder the list, indicating agreement or disagreement with the predicted list. The system was evaluated against this self-curated user data. The set of users who have made changes on their topic profiles were selected, and the initially predicted list of topics was evaluated against the final curated list for each user. FIG. 12 has the statistics of this dataset.

The system was then evaluated using the following metrics on the curated data for mean average precision and normalized discounted cumulative gain.

Mean Average Precision (MAP). For a single user, average precision calculates the average of the precision of the top K topics.

$$AP @ K = {\sum }_{i = 1}^{K} \frac{P @ i}{K +} ,$$

where K⁺ is the number of positive examples. Here P@i is the precision at cut-off i in the retrieved list. The mean average precision for N users at position K is the mean of the average precision for each user, i.e.,

$$MAP @ k = \frac{1}{N} {\sum }_{i = 1}^{N} AP @ K ( i ) .$$

Normalized discounted cumulative gain (nDCG). Measures graded relevance of the list of topics, i.e.,

$$DCG = {\sum }_{i}^{k} \frac{{2}^{{r}_{i}} - 1}{{log}_{2} ( {p}_{i} + 1 )}$$

where rᵢ=1 if the topic has a positive label in the curated list, and pi is the position of topic in the ranked list. Normalized DCG is the ratio of DCG by the model's ranking to the DCG by the ideal ranking:

$$DCG = \frac{DCG}{IDCG} .$$

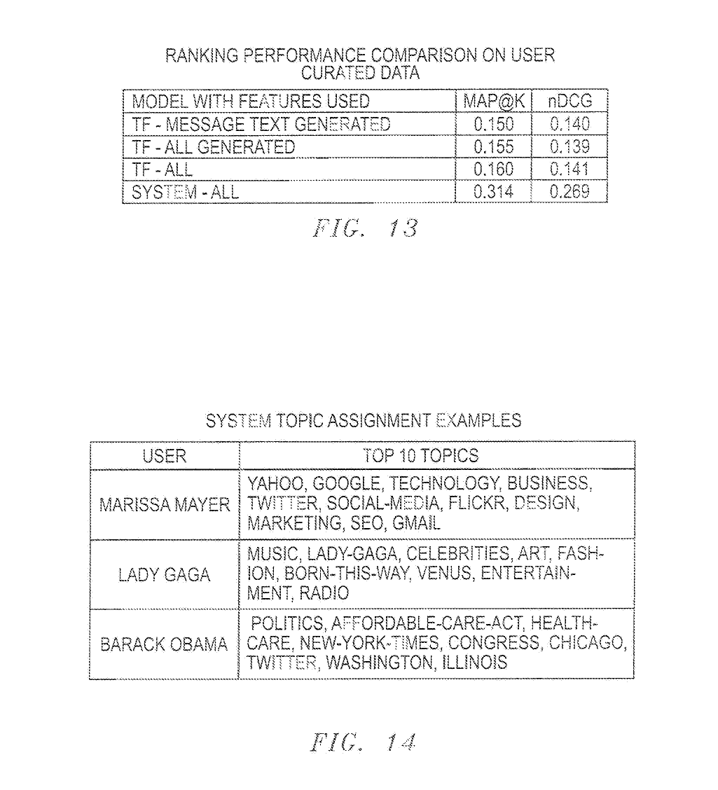

The MAP and nDCG metrics are used to compare the output of the system against other approaches. In particular, the system is compared to approaches where the topics for a user are predicted using aggregated topic frequency (TF) from subsets of features. These subsets are those derived from generated textual input only; all generated inputs including URLs shared, LinkedIn Skills etc.; and all inputs were generated, reacted and credited. FIG. 13 is a table showing an exemplary ranking performance comparison on user curated data. It shows the results for ranking the top K topics of interest for each user, where K=10.

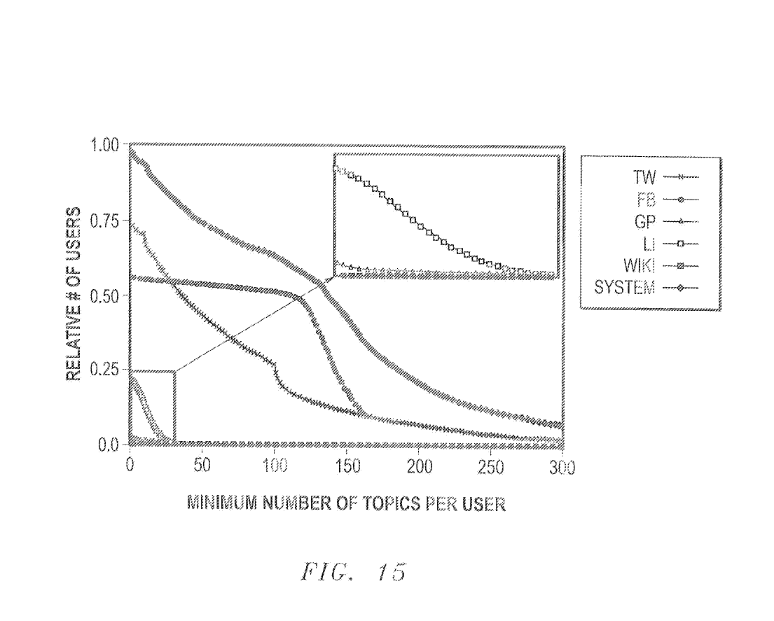

Users who curate their own data are only a small fraction of users in the system representing those who are self-motivated to edit their topic list. Since most users do not edit their list, either because they are satisfied with it, because they are not motivated enough to change it, such users are excluded from the dataset. On this dataset, the system significantly outperforms the other approaches in terms of both the MAP and nDCG metrics, showing that it does indeed produce a better set of ranked topics for a given user. As an example, FIG. 14 is a table showing exemplary topics assigned to some well-known personalities according to the present system.

FIG. 15 is a graph showing an exemplary distribution of registered users for a minimum number of topics assigned across different networks. In the exemplary dataset, around 13% users connect to a single social network, 40% of users to two social networks, and less than 10% users connect to all four social networks. Typically it is expected that a user does not connect all four networks, since most users are only active in one or two networks. But the advantage of using four networks is that the fraction of users using at least two out of the four is higher, leading to more information about the user. Some interesting topical insights across networks include super-topic comparisons and topics distribution.

Super-topics comparison. As discussed previously with regard to FIGS. 4, 5, 6 and 7, phrases used by a user may have low overlap across social networks. In FIG. 15, we show the similarities and differences between topical interests aggregated across users on different networks. To aid visualization, the entities and subtopics are rolled up to super-topics, reducing the topic dimension space from 10,000 to 15. The presence of user interests rolled up to super-topics in each individual social network is summed and this distribution plotted. FIG. 15 shows the percentage breakdown of super-topics on each social network for the users on that network, and also the breakdown across all users according to the system.

From FIG. 15, it is shown that users in each network have distinct topical interests. On FB and TW the super-topic “entertainment” is the most represented one, whereas “business” is the most represented super-topic on LI, and “technology” on GP. FB users are also more interested in topics related to “lifestyle” and “food-and-drink” compared to users on other networks, while a significant number of GP users show interest in “arts-and-humanities”. For LI, apart from “technology” and “business”, other topics are not highly represented, which is expected since it is a professional networking platform. The left-most column shows the distribution of topics as assigned by the system. The “business” row is an interesting one to observe. While this topic is not highly represented on TW, FB, GP, the system is able to assign “business” related topics to users, because it also takes into account signals from LI. This shows that using multiple networks can lead to not only a deeper understanding for each user, but also a better understanding across topics.

Topics distribution. While above cross-network topic distributions are analyzed qualitatively in terms of super-topics, the distribution quantitatively in terms of number of topics assigned to users is assigned. The distributions of a very large number of topics is analyzed in order to perform cross-network comparison. In FIG. 15, each plotted point represents the fraction of users who have at least x number of topics assigned to them. The number of topics assigned to users with TW and FB is much larger than that assigned using GP or LI. This is because GP and LI do not provide API access to graph data, and also have a smaller volume of textual input compared to TW and FB. We conclude from the graph that for the same number of topics, system always assigns topics to more users. Also, system assigns more topics to each user compared to individual networks.

The system supports applications such as targeting, content discovery and question answering.

Targeting. Given that social media is a modern means to spreading awareness among people, many brands desire to target promotional messages and campaigns to social network users. As an example, a car company that wants to spread awareness about a new car model, may want to target certain incentives or “perks” related to the car to some users on social media. When users interested in cars are targeted with the perk, they may be motivated to talk about the car on their respective social networks, effectively generating word-of-mouth awareness about the new model. This approach of the system of targeting users based on topics, can provide value to companies and brand.

Content Discovery. The topics deduced by the system provide utility to users in terms of serendipitous content discovery. This system aggregates online articles, categorized by topic, and ranks them based on relevancy to a user. The system can also identify topics that some members from the user's social graph may be interested in. A user can then be shown a customized feed of articles that he may either want to discover and read about himself, or may want to share with a wider audience on his social networks.

Question Answering. In a question answering scenario, a user in the system can ask a question pertaining to a certain topic, which can then be routed to specific users who may be able to answer the question. For example, a question such as “What is the best place to go fishing near San Francisco?”, may be routed to users interested in fishing who live in San Francisco. Users to whom questions are routed are able to give credible answers to such questions, and the original asker may get multiple good answers.

Some embodiments of the system are implemented as a program product or computer system apparatus for use with a computer system such as, for example, the system shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present system, represent embodiments of the present system.

In general, the routines executed to implement the embodiments of the system, may be part of an operating system or a specific application, component, program, module, object, or sequence of instructions. The computer program of the system typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the system. However, it should be appreciated that any particular program nomenclature that follows is used merely for convenience, and thus the system should not be limited to use solely in any specific application identified and/or implied by such nomenclature.

In addition, embodiments of the system further relate to computer storage products with a computer-readable medium that have computer code thereon for performing various computer-implemented operations. The media and computer code may be those specially designed and constructed for the purposes of the system, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the system has been described in detail with reference to certain preferred embodiments, it should be apparent that modifications and adaptations to those embodiments might occur to persons skilled in the art without departing from the spirit and scope of the system.

What is claimed is:

1. A computed-implemented system for mining expertise and interest topics of social network users across a plurality of computer-based social networks and external data base sources that can be used to generate profit-optimal resource allocations for communication to a social network user, the system comprising:
a computer data store containing:
a plurality of external data base sources containing social network user topics of interest data for the social network user;
a dictionary of topics of interest data phrases to be extracted from the social network and from the external data base sources for the social network user topics of interest data;
a computer server coupled to the computer store and programmed to:
identify social network user topics of interest data associated with the social network user contained on the plurality of social networks;
retrieve the topics of interest data phrases from the social networks and from the external data base sources using the topics of interest data in the dictionary using a test feature extraction function wherein the text extraction feature comprises extracting topics of interest data based on a user profile indicating a user's interest, a user's activities and a user's connections;
map the topics of interest data by assigning them to the social network user using a domain feature mapping function that interacts with the text feature extraction function wherein the domain feature mapping function comprises topic feature generation and attribution for the user;
predict topics of interest for the user based on the topic feature generation and attribution; and
use the predicted topics of interest for the user to generate promotional messages to be sent to the user.

2. The system of claim 1 wherein the attribution for the user denotes the relationship of the input source to the user selected from the group consisting of:
user generated content;
actor generated content generated by a second user in reaction to the user generated content;
credited content which has no direct association with the user; and
social graph generated content generated from topics of interest of other users with which the user has a relationship.

3. The system of claim 1 wherein supervised learning is used to predict the topics of interest for the user.

4. The system of claim 1 wherein the promotional messages are perk targeting.

5. The system of claim 1 wherein the promotional messages contain content comprising articles of interest to the user.

6. A computer-implemented system useful for a commercial enterprise to target promotional messages to be sent to social network users, the system comprising:
a computer data store containing:
a plurality of external data base sources containing social network user topics of interest data for the social network user;
a dictionary of topics of interest data phrases to be extracted from a computer-based social network and from the external data base sources for the social network user topics of interest data;
a computer server coupled to the computer store and programmed to:
identify social network user topics of interest data associated with the social network user contained on the plurality of computer-based social networks;
retrieve the topics of interest data phrases social networks and from the external data base sources using the topics of interest data in the dictionary using a test feature extraction function wherein the text extraction feature comprises extracting topics of interest data based on a user profile indicating a user's interest, a user's activities and a user's connections;
map the topics of interest data by assigning them to the social network user using a domain feature mapping function that interacts with the text feature extraction function wherein the domain feature mapping function comprises topic feature generation and attribution for the user;
predict topics of interest for the user based on the topics feature generation and attribution; and
use the predicted topics of interest for the user to generate promotional messages to be sent to the user.

7. The system of claim 6 wherein supervised learning is used to predicting the topics of interest for the user.

8. The system of claim 6 wherein the promotional messages are perk targeting.

9. The system of claim 6 wherein the promotional messages contain content comprising articles of interest to the user.

10. A non-transitory computer-readable medium with instructions store thereon, that when executed by a processor, perform the steps comprising:
using a plurality of external data base sources hosted on a computer data store containing the social network user topics of interest data for the social network user;
using a dictionary of topics of interest data phrases to be extracted from a computer-based social network and from the external data base sources for the social network user topics of interest data;
identifying social network user topics of interest data associated with the social network user contained on the plurality of computer-based social networks;
retrieving the topics of interest data phrases social networks and from the external data base sources using the topics of interest data in the dictionary using a test feature extraction function wherein the text extraction feature comprises extracting topics of interest data based on a user profile indicating a user's interest, a user's activities and a user's connections;
mapping the topics of interest data by assigning them to the social network user using a domain feature mapping function that interacts with the text feature extraction function wherein the domain feature mapping function comprises topic feature generation and attribution for the user;
predicting topics of interest for the user based on the topic feature generation and attribution; and
using the predicted topics of interest for the user to generate promotional messages to be sent to the user.
